(19) United States
(12) Patent Application Publication
(10) Pub. No.: US 2006/0285867 A1
(43) Pub. Date: Dec. 21, 2006

(54) Method and apparatus for image forming capable of effectively controlling power supply for energy saving

(76) Inventors: Hiroyuki Takahashi, Kanagawa-ken (JP); Tsunehide Takahashi, Tokyo-to (JP); Noriyuki Satoh, Kanagawa-ken (JP)

Correspondence Address: HARNESS, DICKEY & PIERCE, P.L.C., P.O. BOX 8910, RESTON, VA, 20195, US

(21) Appl. No.: 11/455,111

(22) Filed: Jun. 19, 2006

(30) Foreign Application Priority Data
Jun. 20, 2005 (JP) 2005-179247

(51) Int. Cl. G03G 15/20

(52) U.S. Cl. 399/70

(57) ABSTRACT

An image forming apparatus including a plurality of load units, a power supply device, and a control mechanism. The plurality of load units has an image forming mechanism serving as one of the plurality of load units and a specific load component. The power supply device has a first power source to supply a first power to the plurality of load units during a normal operation mode and to provide a second (e.g., minimal) power to the apparatus during an energy saving mode. The power supply device also has a second power source to supply a second power to the specific load component during the energy saving mode. The control mechanism changes a power mode from the normal operation mode to the energy saving mode according to at least one of an instruction for entering into the energy saving mode and satisfaction of a condition that the plurality of load units are inactivated.

### PRIORITY STATEMENT

This patent specification is based on Japanese patent application, No. JPAP2005-179247 filed on Jun. 20, 2005 in the Japan Patent Office, the entire contents of which are hereby incorporated herein by reference.

### BACKGROUND

1. Field

This patent specification generally describes an image forming method and apparatus. More particularly, this patent specification describes a method and apparatus for image forming capable of effectively controlling a power supply for energy saving.

2. Background Art

A background digital multi-function peripheral (MFP) serving as an image forming apparatus includes a plurality of functions such as copying, printing, and transmitting facsimile data. The MFP reads an image to which signal processing (e.g., a shading correction) is performed. The image is then handled digitally so that a variety of functions including an image data accumulation, printing, and a facsimile transmission are provided. The MFP may have a hard disk drive (HDD) for the data processing. However, when the HDD is installed in the MFP, a power supply circuit of the MFP supplies an electric power to the HDD. Thereby, the electric power to the HDD is stopped when the MFP turns on an energy saving mode. For the HDD, a constant rotation of a spindle motor is advantageous in respect of life span. Therefore, the spindle motor is not preferably stopped each time the energy saving mode is turned on. However, in an actual case, the spindle motor is stopped for necessity of the energy saving in the MFP.

FIG. 1 is a schematic diagram illustrating typical connections according to the Background Art of a power saving system capable of controlling a power supply of a MFP. In the background MFP of FIG. 1, when a switch SW1 for power supply is turned on, a power supply unit PSU 1 supplies the electric power to a control circuit 2 and a HDD 3. The control circuit 2 includes various circuits for performing image forming functions such as reading, image processing, and writing. The control circuit 2 further includes drive circuits for driving various mechanical and electromechanical components and a controller for controlling entire operations of the background MFP. The HDD 3 stores information such as a control program and image data. When a switch SW2 for energy saving is pushed, or the MFP is not used for a certain period of time, the MFP moves to the energy saving mode so that an electric power consumption may be reduced. In the energy saving mode, the control circuit 2 generates an energy saving signal for cutting off switches SW4 and SW5 to turn off a 5V power supply and a HDD power supply, respectively, and continuously activating a 5VE power supply to be supplied to a circuit 2a which is needed to be active for a minimum operation of the controller. Thus, the control circuit 2 can be activated, among various circuits of the control circuit 2, at least the circuit 2a during the energy saving mode. The energy saving mode is returned by pushing a return switch SW3. A cause of returning from the energy saving mode may include a case where a pressing plate is opened or an original document is set on an automatic document feeder (ADF) for copying by the MFP.

The circuit 2a which is ON during the energy saving in the controller detects a case when the SW3 is pushed so that the energy saving signal is controlled, and thereby, the switches SW4 and SW5 of the PSU 1 become ON for supplying the power supply to the control circuit 2 and the HDD 3. When the power supplies (i.e., the 5V and HDD power supplies) become ON again, for example, the circuits for reading, image processing, and writing, and the drive circuit are initialized, or a program which is necessary for the operation of the controller is downloaded from the HDD 3.

FIG. 2 is a table illustrating operative conditions of the switches for the Background Art MFP of FIG. 1.

For the switch operations, symbols “1” and “0” indicate ON and OFF, respectively. For the switches SW2 and SW3, a symbol “1↓” indicates pushing the SW2 and SW3. As the SW2 and SW3 are push switches, switches are returned after being depressed.

For the energy saving signal, symbols “1” and “0” indicate during the normal state (i.e., during a non-energy saving) and during the energy saving respectively. A symbol “—” indicates that an output is undefined when the power supply is not supplied to the control device or the switch SW1 is OFF.

In a situation No. 1 of FIG. 2, the SW1 is OFF. Thereby, the switches are all OFF, and the HDD 3 is not supplied with the HDD power supply.

In a situation No. 2, the SW1 is ON in the normal state while the SW4 and SW5 of the PSU 1 are ON.

A situation No. 3 is in a state of the energy saving mode by pushing the SW2, and thereby the SW4, the SW5 and the power supply of the HDD 3 are OFF.

A situation No. 4 is a return state from the energy saving mode by pushing the SW3. The SW4, the SW5, and the HDD3 are ON again.

As is clear from FIG. 2, transitional power conditions of the HDD 3 from the situation No. 1 to the situation No. 2 and the situation No. 3 to the situation No. 4 are the same, both OFF to ON. Since the spindle motor needs a certain time period to rotate at a stable speed, the HDD 3 halting in the energy saving mode cannot immediately be operative in the return mode, and therefore the program cannot be downloaded until the spindle motor is fully initiated. Consequently, an excess time is required for returning from the energy saving mode. Similarly, a Polygon Mirror Scanner Motor (Polygon Motor) for the writing needs the time for the initiation, and thereby the excess time is needed for returning from the energy saving mode. A shortening of the time necessary for returning from the energy saving mode may be achieved by constantly rotating the HDD or the polygon motor. However, this constant rotation is not performed during the energy saving mode due to an increase in the electric power consumption.

### SUMMARY

An embodiment of the present invention provides an image forming apparatus including a plurality of load units, a power supply device, and a control mechanism. The plurality of load units has an image forming mechanism serving as one of the plurality of load units and a specific load component. The power supply device has a first power source to supply a first power to the plurality of load units during a normal operation mode and to supply a second (e.g., minimal) power to the apparatus during an energy saving mode. The power supply device also has a second power source to supply a second power to the specific load component during the energy saving mode. The control mechanism changes a power mode from the normal operation mode to the energy saving mode according to at least one of an instruction for entering into the energy saving mode and satisfaction of a condition that the plurality of load units is inactivated.

An embodiment of the present application provides a power saving method including a plurality of steps. The power saving method provides the first power source to supply the first power to the plurality of load units of a host apparatus during the normal operation mode and to supply a second power to the host apparatus during the energy saving mode. The power saving method provides the second power source to supply the second power to the specific load component included in the plurality of load units during the energy saving mode. The power saving method generates an energy saving signal at an instruction for entering into the energy saving mode. The power saving method changes the power mode from the normal operation mode to the energy saving mode according to at least one of an instruction for entering into the energy saving mode and satisfaction of a condition that the plurality of load units is inactivated.

Additional features and advantages of the present invention will be more fully apparent from the following detailed description of example embodiments, the accompanying drawings and the associated claims.

### BRIEF DESCRIPTION OF THE DRAWINGS

A more complete appreciation of the disclosure and many of the attendant advantages thereof will be readily obtained as the same becomes better understood by reference to the following detailed description of example embodiments when considered in connection with the accompanying drawings, wherein:

FIG. 1 is a schematic diagram of a power saving system of a background multi-function peripheral (MFP) according to the Background Art;

FIG. 2 is a table summarizing operating states of switches in the Background Art power saving system of FIG. 1;

FIG. 3 is a schematic diagram of a multi-function peripheral (MFP) according to an example embodiment of the present invention;

FIG. 4 is a schematic diagram of a power saving system of the MFP illustrated in FIG. 3, according to an example embodiment of the present invention;

FIG. 5 is a schematic diagrams of a power saving system according to another example embodiment of the present invention;

FIG. 6 is a schematic diagram of a power saving system according to yet another example embodiment of the present invention;

FIG. 7 is a table summarizing operating states of switches used in the power saving system illustrated in FIG. 4;

FIG. 8 is a table summarizing operating states of switches used in the power saving system illustrated in FIG. 5;

FIG. 9 is a table summarizing operating states of switches used in the power saving system illustrated in FIG. 6; and

FIG. 10 is a table summarizing relationships among an energy saving signal, an inverter output, a voltage monitoring signal, an AND gate output, and a switch between a capacitor and a hard disk drive in the power saving system of FIG. 6.

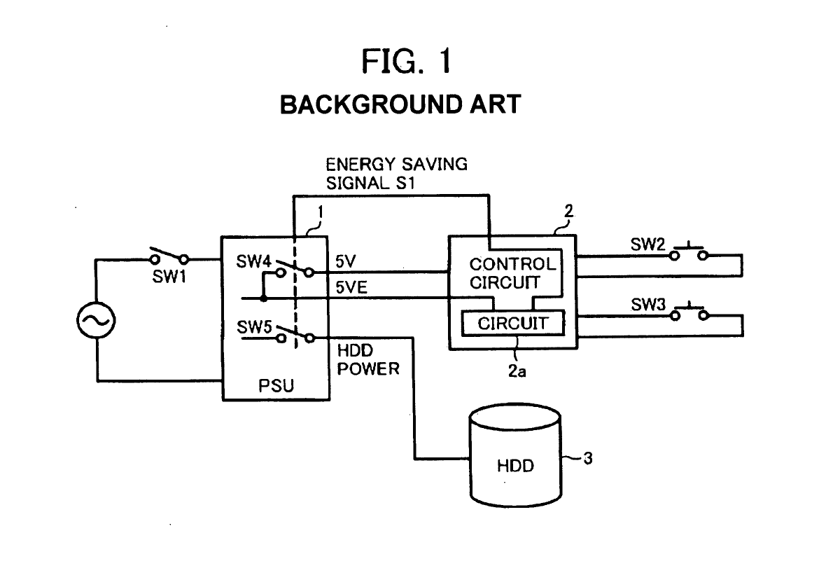

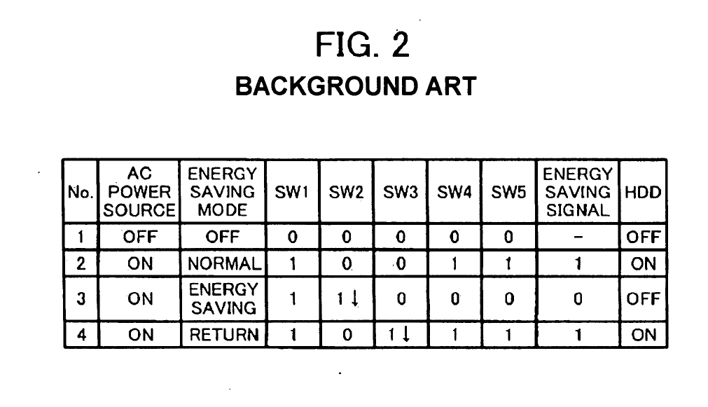

The accompanying drawings are intended to depict example embodiments of the present invention and should not be interpreted to limit the scope thereof. The accompanying drawings are not to be considered as drawn to scale unless explicitly noted.

### DETAILED DESCRIPTION OF EXAMPLE EMBODIMENTS

It will be understood that if an element or layer is referred to as being “on,” “against,” “connected to” or “coupled to” another element or layer, then it can be directly on, against connected or coupled to the other element or layer, or intervening elements or layers may be present. In contrast, if an element is referred to as being “directly on”, “directly connected to” or “directly coupled to” another element or layer, then there are no intervening elements or layers present. Like numbers refer to like elements throughout. As used herein, the term “and/or” includes any and all combinations of one or more of the associated listed items.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer or section from another region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner. Reference is now made to the drawings, wherein like reference numerals designate identical or corresponding parts throughout the several views.

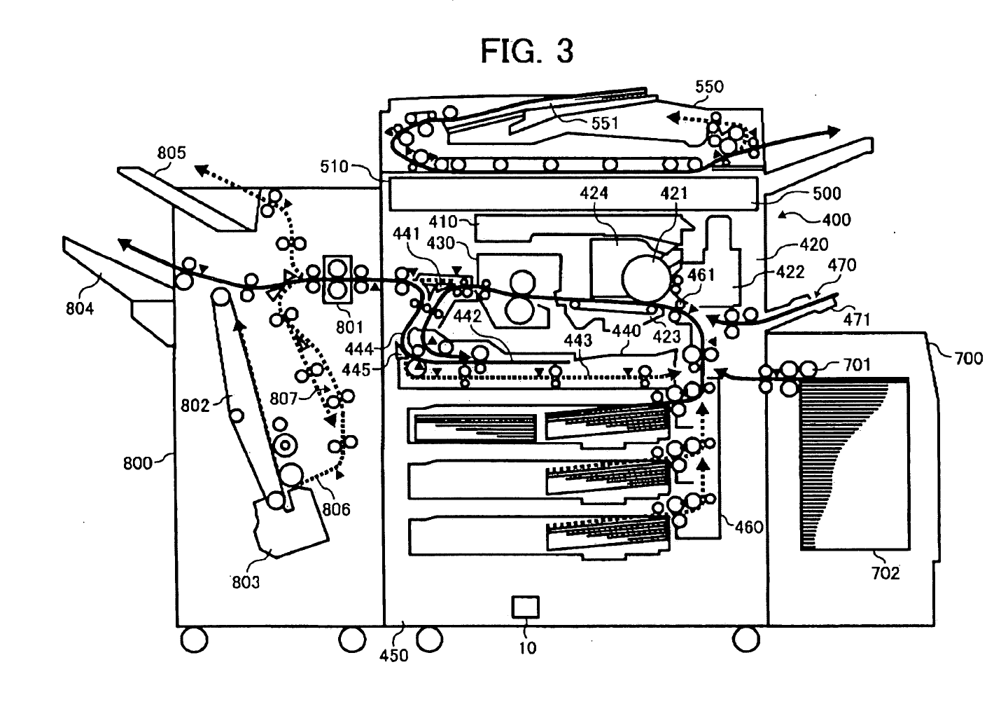

FIG. 3 is a schematic diagram of a multifunction peripheral (MFP) serving as an image forming apparatus according to an example embodiment of the present invention.

Referring to FIG. 3, the MFP capable of forming a monochrome image includes a main body 400, an image reading device 500, an automatic document feeder (ADF) 550, a large capacity tray (LCT) 700, and a finishing device 800.

As illustrated in FIG. 3, the main body 400 includes a power saving system 10, an image writing unit 410, an image forming unit 420, a fixing unit 430, a reversal unit 440, a sheet feeding unit 450, a vertical conveyance unit 460, a registration roller 461, and a manual feeding unit 470.

The power saving system 10 includes various electrical units performing functions of reading, image processing, optical writing, and so on, and details will be described below.

The image writing unit 410 uses a laser diode (LD) as a light emission source and includes various optical components such as a polygon mirror and an fθ lens, for example, forming an optical scanning system. The image writing unit 410 drives the LD with modulation based on image information of an original document read by the image reading device 500 so as to perform a laser writing to the photoconductor drum 421 through the optical scanning system. As a result of the laser writing, an electrostatic latent image is formed on a surface of the photoconductor drum 421.

The image forming unit 420 includes various image forming elements of an electrophotographic method known in the art, including, for example, a photoconductor drum 421, a development unit 422, a transfer unit 423, a cleaning unit 424, and a discharge unit (not shown). These image forming elements are placed in a suitable order along an outer circumference of the photoconductor drum 421. The image forming unit 420 carries an electrostatic latent image formed by the image writing unit 410 on the surface of the photoconductor drum 421. The image forming unit develops the electrostatic latent image with toner by the development unit 422, and transfer the developed toner image onto a transfer sheet by the transfer unit 423. The cleaning unit 424 removes residual toner remaining on the surface of the photoconductor drum 421 after the image transfer. The discharge unit discharges the surface of the photoconductor drum 421 before a start of a next image forming process.

The fixing unit 430 fixes an image carried on the transfer sheet.

The reversal unit 440 includes a first switching tab 441, a reversal path 442, a duplex path 443, a finishing path 444, and a second switching tab 445. The reversal unit 440 is placed at a position downstream side from the fixing unit 430 in a sheet conveyance direction in which a transfer sheet (i.e., a recording medium, e.g., paper). The first switching tab 441 switches back and forth between the sheet conveyance directions of the transfer sheet to the reversal unit 440 and the finishing device 800. The duplex path 443 conveys the transfer sheet reversed by the reversal path 442 towards the image forming unit 420, and the finishing path 444 conveys the reversed transfer sheet to the finishing device 800. The second switching tab 445 is placed at a branch point between the duplex path 443 and the finishing path 444, and switches back and forth between the sheet conveyance directions of the reversed transfer sheet to the duplex path 443 and the finishing path 444.

The sheet feeding unit 450 includes a plurality of sheet feeding units each for storing the transfer paper. The transfer paper in each one of the sheet feeding units is extracted by a pickup roller and a feed roller so that a selected transfer sheet is guided to the vertical conveyance unit 460. The vertical conveyance unit 460 conveys the transfer sheet from each sheet feeding unit to the registration roller 461 which is located at a position immediately before the transfer unit 423 in the sheet conveyance direction. The registration roller 461 times a leading edge of a developed toner image carried on the photoconductor 421 so as to feed the transfer sheet to the transfer unit 423.

The manual feeding unit 470 includes a manual feeding tray 471 which is manually opened and closed. The manual feeding tray 471 is opened as may be needed so that the transfer sheet is supplied manually. The transfer sheet entered through the manual feeding tray 471 is stopped by the registration roller 461 which then times the conveyance of the transfer sheet to the image forming unit 420.

The LCT 700 stacks and supplies relatively large quantities of the transfer sheet of the same size. This device 700 is configured to elevate a bottom board 702 as the transfer sheet is consumed so as to be capable of consistently picking up the transfer sheet from a pickup roller 701. The transfer sheet fed from the pickup roller 701 is conveyed to a nip part of the registration roller 461 from the vertical conveyance unit 460.

The finishing device 800 includes a punch 801, a staple tray 802, a stapler 803, a shift tray 804, a proof tray 805, a lower conveyance path 806, and a pre-stack conveyance path 807. In a case of making a hole, the transfer sheet conveyed to the finishing device 800 from the main body 400 is punched per sheet by the punch 801, and is ejected to the proof tray 805 if there is no further process. In a case of sorting and stacking, the transfer sheet is ejected to the shift tray 804. In this example embodiment, the shift tray 804 performs a sorting operation by a reciprocating movement in a direction perpendicular to the sheet conveyance direction. As an alternative to this reciprocating movement, the transfer sheet may be sorted by being moved in a direction perpendicular to the sheet conveyance direction at the sheet conveyance path.

In a case of alignment, the transfer sheet with or without holes is guided to the lower conveyance path 806 so as to be aligned in a direction perpendicular to the sheet conveyance direction by a tailing edge fence and in a direction parallel to the sheet conveyance direction by a jogger fence in the staple tray 802. In a case of stapling, a location on a batch of the aligned sheet is bound by the stapler 803, and is then ejected to the shift tray 804 by an ejection belt (not shown). The location on the aligned sheet is, for example, a corner or two locations in center. The pre-stack conveyance path 807 is disposed to the lower conveyance path 806 so as to stack a plurality of transfer sheets at the time of conveyance, and thereby, an image forming operation in a finishing stage in the main body 400 may be substantially reduced, if not prevented, from discontinuation.

The image reading device 500 is guided on a contact glass 510 by the ADF 550 so as to perform an optical scanning operation for optically scanning a still original. Then, the image reading device 500 reads a scanned image which is formed by an imaging lens via a first through third mirrors (not shown) by a photoelectric transducer including a CCD (charge-coupled device) and a CMOS (complementary metal oxide semiconductor). An image process is performed by an image process circuit (not shown) on image data which is read. Then, the image data is temporally stored in a memory device (not shown). The image data is read from the memory device by the image writing unit 410 in image forming, and is modulated for optical writing.

The ADF 550 includes a function of reading both sides of a transfer sheet. The ADF 550 is opened and closed freely, and is disposed to an installation surface of the contact glass 510 of the image reading device 500. In the ADF 550, an original placed on an original placing table 551 is automatically sent on the contact glass 510 when the original is read.

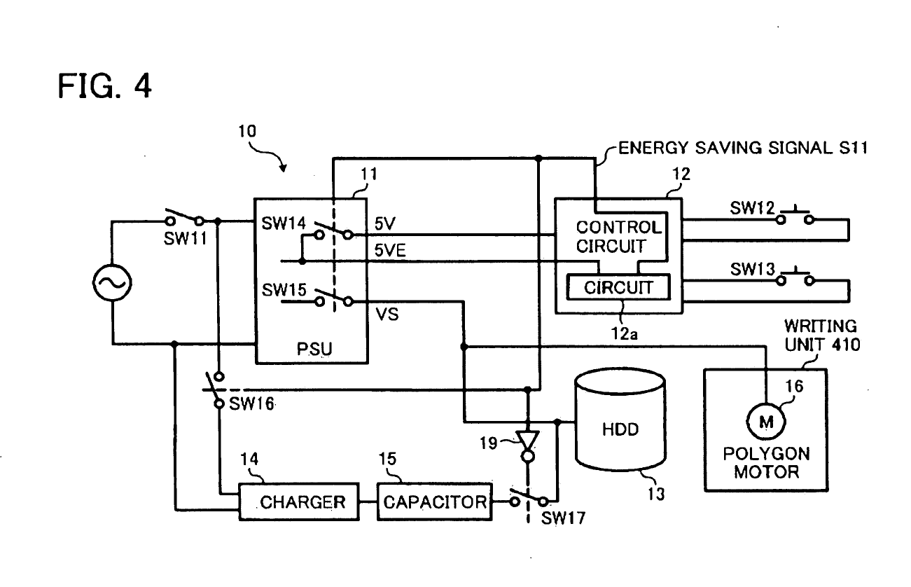

FIG. 4 is a schematic diagram of a power saving system of the MFP illustrated in FIG. 3, according to an example embodiment of the present invention.

Referring to FIG. 4, the power saving system 10 of FIG. 3 is illustrated. As illustrated in FIG. 4, the power saving system 10 includes a power supply unit (PSU) 11, a control circuit 12, a charger 14, a capacitor (e.g., an electric double capacitor) 15, an inverter 19, and switches SW11, SW12, SW13, SW16, and SW17. In FIG. 4, the power saving system 10 is connected to a HDD 13 and a polygon motor 16 of the image writing unit 410 to supply power to these components. The PSU 11 includes switches SW14 and SW15, and supplies entire powers needed by the MFP, including powers for the control circuit 12, the HDD 13, and the polygon motor 16. In FIG. 4, a supplemental power supply VS is supplied to drive the components including the HDD and the polygon motor.

The control circuit 12 includes a circuit 12a, and controls entire operations of the MFP. The control circuit 12 generates an energy saving signal S11 for initiating an energy saving mode of the MFP.

The switch SW16 is a switch for supplying an alternating current power supply to the charger 14, and the switch SW17 is for supplying the power supply to the HDD 13 and the polygon motor 16 of the image writing unit 410 from the capacitor 15. The inverter 19 drives the switches SW16 and SW17 based on the energy saving signal S11. The circuit 12a is used when the energy saving mode is ON. Details of the PSU 11, control circuit 12, and HDD 13 are omitted because these units operate in a known manner when the switch SW11 is turned on.

The energy saving signal S11 outputting from the control circuit 12 turns on the switch SW16 so that an alternating current voltage is supplied to the charger 14. At this point, the switch SW17 is OFF. The charger 14 charges a device having a storage function. For example, as illustrated in FIG. 4, this example embodiment uses the capacitor (e.g., an electric double-layer capacitor) 15 as such the device because of favorable features including a small size, a large capacity, a life span, and maintenance-free. As an alternative, the devices such as a lead acid battery and lithium battery may also be used.

When the switch SW12 is pushed, or the MFP is not used for a certain period of time, the control circuit 12 generates the energy saving signal S11 so as to cause the MFP to enter into the energy saving mode, and the switch SW14 is turned off. Consequently, the PSU 11 is caused to stop supplying the power to a unit or a circuit (e.g., a scanner or an operation part) which is not necessarily operated during the energy saving. Also, the switch SW15 is blocked so as to cut off the power supply to the HDD 13.

At this time, the switch SW17 is turned on by a signal which is an inverted signal of the energy saving signal S11 (i.e., an output of the inverter 19) so as to supply the power to the HDD 13 from the capacitor 15 instead of the PSU 11. Simultaneously, the alternating current voltage supplying to the charger 14 is blocked by turning off the switch SW16.

Therefore, the HDD 13 is supplied with the power by the capacitor 15, and a spindle motor (not shown) of the HDD 13 constantly rotates even in the energy saving mode. Thereby, a restart time for the spindle motor may be shortened when the switch SW13 is pushed, or when another operator action for restarting the operation is made. For example, an operator may close a pressing plate of the image reading device 500 which is opened, or set an original document on the ADF 550. In such case, the alternating current power supply supplied to the charger 14 is cut off so that an electric power consumption is not increased.

When the operator restarts the operation by, for example, pushing the switch SW13, the switches SW14 and SW15 are turned on so that the power is supplied from the PSU 11 to the control circuit 12 and the HDD 13. Also, the capacitor 15 is separated from the HDD 13 so as to be in a charging state by turning on the switch SW16.

Operations of the HDD 13 in the energy saving mode are described above, however, operations are the same for the polygon motor 16 of the image writing unit 410 and a unit having a motor.

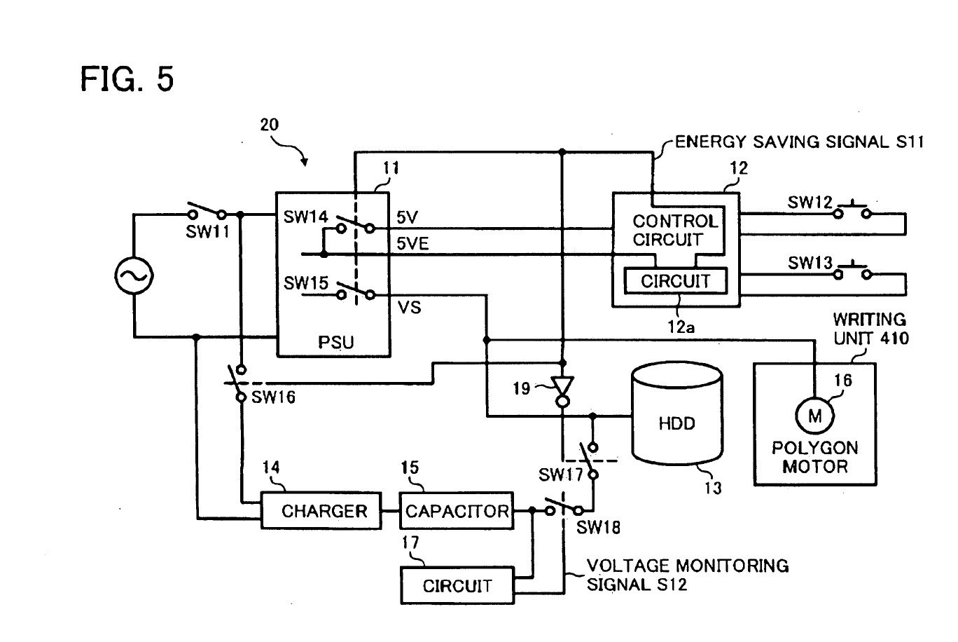

FIG. 5 is a schematic diagrams of a power saving system according to another example embodiment of the present invention.

Referring to FIG. 5, a power saving system 20 according to another example embodiment is explained. As illustrated in FIG. 5, the power saving system 20 is similar to the power saving system 10 of FIG. 4, except for a voltage monitoring circuit 17 and a switch SW18. The power saving system 20 may be used in the image forming apparatus instead of the power saving system 10 of FIG. 4.

The voltage monitoring circuit 17 is connected to the capacitor 15, and the switch SW18 is connected between the capacitor 15 and the switch SW17. The voltage monitoring circuit 17 generates a voltage monitoring signal S12 to switch the switch SW17 back and forth between on and off. The voltage monitoring circuit 17 monitors an output voltage of the capacitor 15. In the energy saving mode, the capacitor 15 discharges, and the power supply to the HDD 13 and the polygon motor 16 becomes blocked by the switch SW18 when the voltage of the capacitor 15 falls below a reference level. The reference voltage level is a minimum voltage needed to cause the rotation of the spindle motors of the HDD 13 and the polygon motor 16. The power supplied by the capacitor 15 is not sufficient to rotate spindle motors of the HDD 13 and the polygon motor 16 after the voltage on the capacitor 15 has fallen below the reference voltage level.

Therefore, the capacitor 15 does not overly discharge so as to immediately reach in a fully charged state in a case of charging according to this example embodiment in FIG. 5.

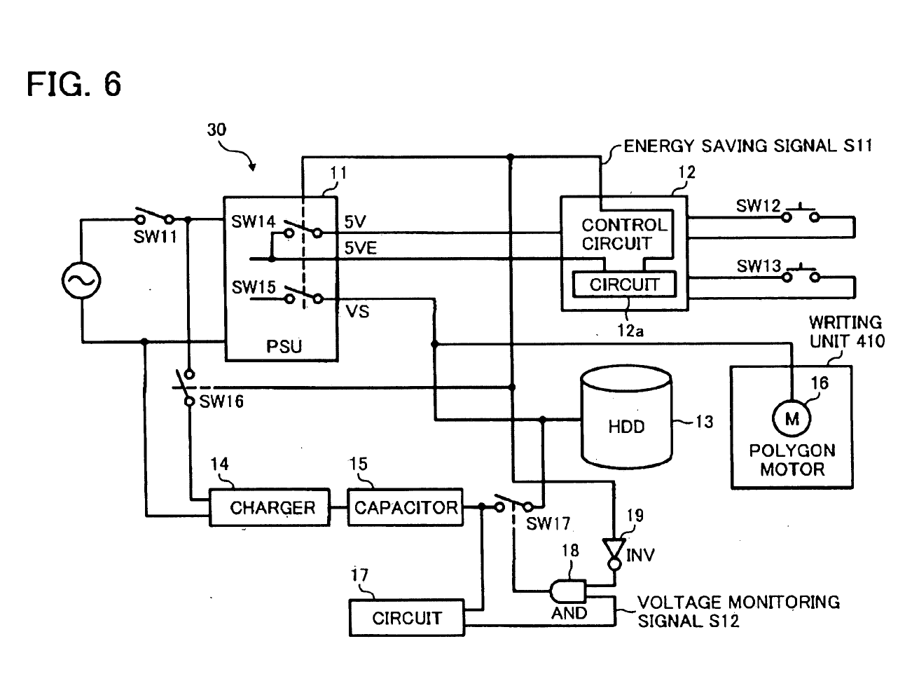

FIG. 6 is a schematic diagram of a power saving system according to yet another example embodiment of the present invention.

Referring to FIG. 6, a power saving system 30 according to another example embodiment is explained. As illustrated in FIG. 6, the power saving system 30 is similar to the power saving system 10 of FIG. 4, except for the voltage monitoring circuit 17 (see FIG. 5), a two-input AND gate 18, and the inverter 19 (see FIG. 5). The power saving system 30 may be used in the image forming apparatus instead of the power saving system 10 of FIG. 4.

In FIG, 6, the switch SW17 is operated by an output of the two-input AND gate 18 receiving an output of the inverter 19 (i.e., the inverted signal of the energy saving signal S11) and the voltage monitoring signal S12 output from the voltage monitoring circuit 17.

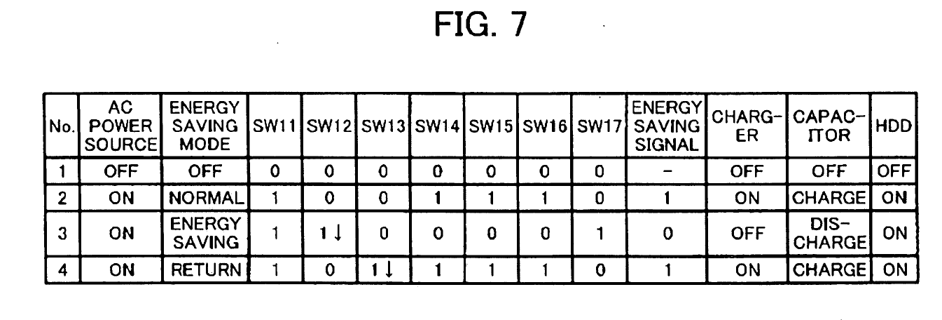

FIGS. 7 through 9 summarize operative conditions of the switches used in the circuits of FIGS. 4 through 6, respectively.

Regarding the switch operations, symbols “1” and “0” indicate ON and OFF, respectively.

Regarding the switches SW12 and SW13, a symbol “1↓” indicates pushing the SW12 and SW13. As the switches SW12 and SW13 are push switches, switches are returned after being depressed. With the symbol “1↓”, the switches SW12 and SW13 turn to “1” (i.e., ON) for the time being and then turn to “0” (i.e., OFF). For example, an energy saving release switch is turned OFF after being ON for a short period of time. In a case of a pressure plate opening-closing sensor, the switch is turned ON when a pressure plate such as a pressure plate of an original document setting table is opened, and the switch is turned OFF when the pressure plate is closed. The pressure plate opening-closing sensor detects an opening of the ADF of the MFP described above. Also, in a case of the ADF, the switch is turned ON when an original document is set on the ADF, and is turned OFF when all of the original documents are read.

Regarding the energy saving signal, symbols “1” and “0” indicate during the normal state (i.e., during a non-energy saving) and during the energy saving respectively. A symbol “—” indicates that an output is undefined when the power supply is not supplied to the control device or the power supply switch SW11 is OFF.

Regarding the voltage monitoring signal, symbols “1” and “0” indicate that the voltage of the capacitor 15 is at or above the reference level and below the reference level respectively. A symbol “—” indicates that an output is undefined when power is not supplied to the voltage monitoring circuit 17 or the power supply switch SW11 is OFF.

FIG. 7 is a table summarizing the operative conditions of the switches corresponding to FIG. 4.

In a situation No. 1 found in FIG. 7, the power supply switch SW11 is OFF, thereby, all the switches are OFF, and the power supplies to the charger 14 of the capacitor 15 and the HDD 13 of the capacitor 15 are also OFF.

In a situation No. 2 found in FIG. 7, the power supply switch SW11 is ON in the normal state, and the switches SW14 and SW15 of the PSU 11 are ON. The charger 14 is ON so that the capacitor 15 is charged.

A situation No. 3, found in FIG. 7, is in the energy saving mode by pushing the SW12. The switches SW14 and SW15 of the PSU 11 are OFF. The HDD 13 is operated even in the energy saving mode by discharging the capacitor 15. The charger 14 is OFF so that consumption current does not increase.

A situation No. 4, found in FIG. 7, is in the return state which is returned from the energy saving mode by pushing the SW13. The switches SW14 and SW15 of the PSU 11 are ON again. The HDD 13 is operated by the PSU 11. Here, an initiation time is shortened because the spindle motor is being rotated. The capacitor 15 is charged.

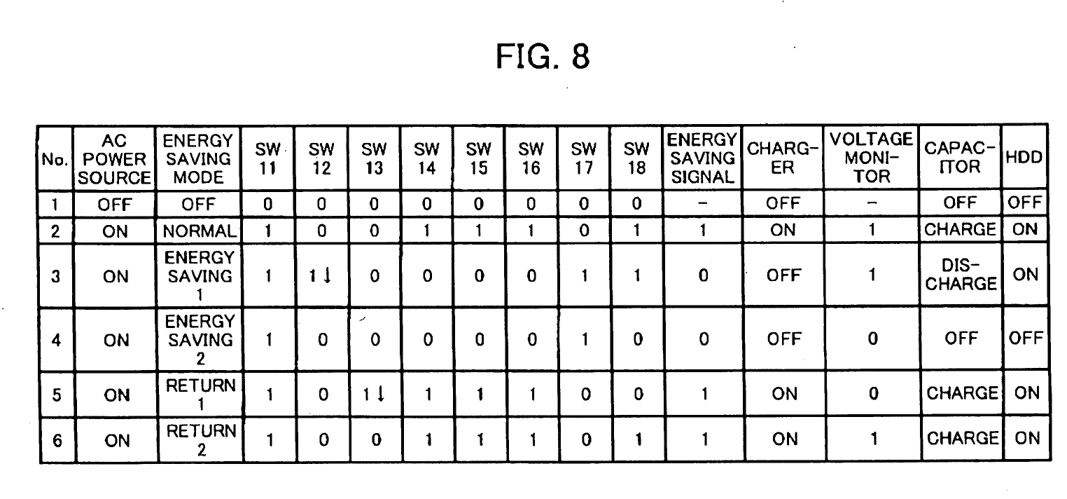

FIG. 8 is a table summarizing the operative conditions of the switches corresponding to FIG. 5.

A situation No. 1, found in FIG. 8, is in a state where the power supply switch SW11 is OFF. Thereby, the power supplies to the charger 14 of the capacitor 15, the voltage monitoring circuit 17, the HDD 13 of the capacitor 15 are OFF.

A situation No. 2, found in FIG. 8, is in the normal state where the switch SW11 is ON. The charger 14 is ON, and the capacitor 15 is charged. When the voltage of the capacitor 15 is at or above the reference level, the output of the voltage monitoring circuit 17 turns to “1”, and the switch SW18 is turned ON.

A situation No. 3, found in FIG. 8, is in the energy saving mode by pushing the switch SW12. The HDD 13 is operated in the energy saving mode by discharging the capacitor 15. The charger 14 is OFF so that the consumption current does not increase.

A situation No. 4, found in FIG. 8, is still in the energy saving mode while the voltage of the capacitor 15 is below the reference level. Thereby, the output of the voltage monitoring circuit 17 turns to “0”, and the power supply to the HDD 13 is blocked.

A situation No. 5, found in FIG. 8, is in the return state from the energy saving mode by pushing the switch SW13. The HDD 13 is operated by the PSU 11. In this situation, the initiation time is not shortened because the spindle motor is not being rotated. The capacitor is charged, but the voltage of the capacitor is not recovered to a sufficient level. Thereby, the output voltage of the voltage monitoring circuit 17 is “0”.

In a situation No. 6, found in FIG. 8, the voltage of the capacitor 15 is recovered to the sufficient level so that the voltage of the voltage monitoring circuit 17 turns to “1”.

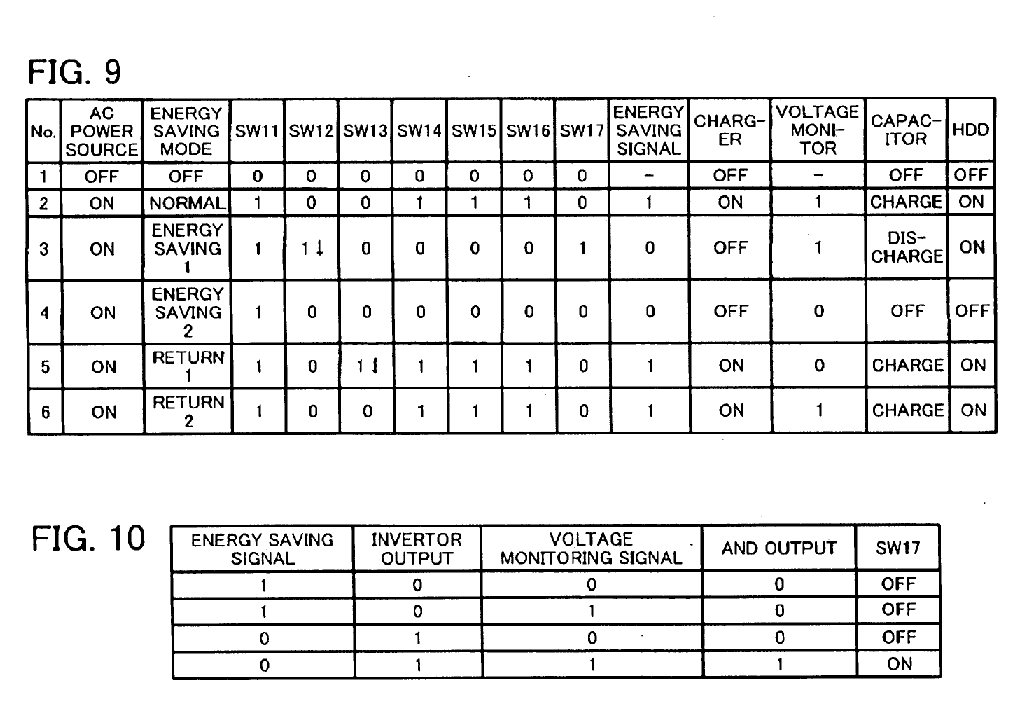

FIG. 9 is a table summarizing the operative conditions of the switches corresponding to FIG. 6. FIG. 9 is similar to Table 3 of FIG. 8 except regarding the switches SW17 and SW18. The switches SW17 and SW18 are used in FIG. 8 while the switch SW17 is used in FIG. 9. The switch SW17 of FIG. 9 is ON when the energy saving signal is “0” and the voltage monitoring signal is “1” based on information in the table of FIG. 10, summarizing logical values described below.

The table of FIG. 10 demonstrates logical values describing relationships among the energy saving signal S11, the inverter output, the voltage monitoring signal S12, an output of the AND gate, and the switch SW17 in FIG. 9. As symbols used in FIG. 10 are same as FIG. 7 through FIG. 9, explanation of the symbols is omitted.

The switch SW17 is OFF when the energy saving signal is “1”, the inverter output is “0” (i.e., OFF), the voltage monitoring signal is “0”, and the output of the AND gate is “0” (i.e. OFF).

The switch SW17 is also OFF when the energy saving signal is “1”, the inverter output is “0”, the voltage monitoring signal is “1” and the output of the AND gate is

The switch SW17 is also OFF when the energy saving signal is “0”, the inverter output is “1” (i.e., ON), the voltage monitoring signal is “0” and the output of the AND gate is “0”.

The switch SW17 is ON only when the energy saving signal is “0”, the inverter output is “1”, the voltage monitoring signal is “1” and the output of the AND gate is “1” (i.e. , ON).

Therefore, one or more of the following effects may be achieved according to one or more embodiments of the present invention, respectively.

In a device having the energy saving mode, the return time from the energy saving mode is required to be short. In a case where a unit consumes a rising time, a second power supply such as the capacitor is being operated during the energy saving mode so that the return time from the energy saving mode may be shorten without increasing the electric power consumption.

The spindle motor of the HDD is being operated even during the energy saving mode so that the initiation time is shortened when returning from the energy saving mode. Thereby, the return time may be shortened.

The polygon motor of the writing unit is being operated even during the energy saving mode so that the initiation time is shortened when returning from the energy saving mode. Thereby, the return time may be shortened.

The capacitor is used as the second power supply having the storage function so that the small size, the large capacity, the long life span, and the maintenance-free are achieved. The capacitor is not charged during the energy saving mode so that an increase in the electric power consumption may be reduced, if not prevented.

A given circuit is only being operated during the energy saving mode with the energy saving signal so that the electric power consumption is reduced. Also, the second power supply is controlled by the energy saving signal, and the unit consuming the rising time is supplied with the power supply during the energy saving so that the return time from the energy saving is shortened.

The voltage of the capacitor is monitored so that an excess of the electric discharge is reduced, if not prevented, and a time for fully charging may be shortened.

A mechanism to supply the power supply from the capacitor to a device such as the HDD, and a mechanism to block the power supply when the voltage of the capacitor reduces are commonly used. Thereby, a number of the switch elements may be reduced.

In a case of reducing the number of the switch elements, a logical circuit is configured so as to be executed by a small number of parts.

Numerous additional modifications and variations are possible in light of the above teachings. It is therefore to be understood that within the scope of the appended claims, the disclosure of this patent specification may be practiced otherwise than as specifically described herein.

Further, elements and/or features of different example embodiments may be combined with each other and/or substituted for each other within the scope of this disclosure and appended claims.

What is claimed is:

1. An image forming apparatus comprising:
a plurality of load units including
an image forming mechanism serving as one of the plurality of load units, and
a specific load component; and
a power supply device including
a first power source to supply a first power to the plurality of load units during a normal operation mode and to supply a second power less than the first power to the apparatus during an energy saving mode, and
a second power source to supply a second power to the specific load component during the energy saving mode; and
a control mechanism to change a power mode from the normal operation mode to the energy saving mode according to at least one of an instruction for entering into the energy saving mode and satisfaction of a condition that the plurality of load units is inactivated.

2. The apparatus of claim 1, wherein the specific load component includes a hard disc drive and the second power from the second power source is used to drive a spindle motor of the hard disc drive during the energy saving mode.

3. The apparatus of claim 1, wherein the specific load component includes an image writing unit and the second power from the second power source is used to drive a polygon motor of the image writing unit during the energy saving mode.

4. The apparatus of claim 1, wherein the second power source includes a charger and an electric double-layer capacitor.

5. The apparatus of claim 1, further comprising:
a circuit to shut off a power supply from an alternating current power source to the charger during the energy saving mode.

6. The apparatus of claim 1, wherein, at an instruction for entering into the energy saving mode, the control mechanism generates and sends an energy saving signal to the first power source for substantially shutting down the first power except for the second power to be used by the control mechanism during the energy saving mode.

7. The apparatus of claim 6, further comprising:
a voltage monitoring mechanism to monitor an output voltage of the second power source and to switch off a power supply line from the second power source to the specific load component when detecting an event that the output voltage of the second power source is smaller than a reference value.

8. The apparatus of claim 7, wherein the specific load unit is connected to the second power source according to the energy saving signal during the energy saving mode, and the specific load unit is disconnected from the second power source when the voltage monitoring system detects the output voltage of the second power source is smaller than the reference value.

9. The apparatus of claim 7, further comprising:
a first switch to connect the specific load unit to the second power source according to the energy saving signal during the energy saving mode; and
a second switch to disconnect the specific load unit from the second power source when the second power source reduces an output voltage below the reference value.

10. The apparatus of claim 7, further comprising:
a switch to connect the specific load unit to the second power source according to the energy saving signal during the energy saving mode; and
a logical circuit to disconnect the specific load unit from the second power source when the second power source reduces an output voltage below a threshold value based on the energy saving signal and a signal output from the voltage monitoring mechanism.

11. A power saving system supplying power to a plurality of load units of a host apparatus, the system comprising:
a first power source to supply a first power to the plurality of load units during a normal operation mode and to supply a second power less than the first power to the host apparatus during an energy saving mode, and
a second power source to supply a second power to a specific load component included in the plurality of load units during the energy saving mode; and
a control mechanism to change a power mode from the normal operation mode to the energy saving mode when the plurality of load units are inactivated.

12. The power saving system of claim 11, wherein the specific load component includes a hard disc drive and the second power from the second power source is used to drive a spindle motor of the hard disc drive during the energy saving mode.

13. The power saving system of claim 11, wherein the specific load component includes an image writing unit and the second power from the second power source is used to drive a polygon motor of the image writing unit during the energy saving mode.

14. The power saving system of claim 11, wherein the second power source includes a charger and an electric double-layer capacitor.

15. A power saving method comprising:
providing a first power source to supply a first power to a plurality of load units of a host apparatus during a normal operation mode and to supply a second power less than the first power to the host apparatus during an energy saving mode;
providing a second power source to supply a second power to a specific load component included in the plurality of load units during the energy saving mode;
generating an energy saving signal at an instruction for entering into the energy saving mode; and
changing a power mode from the normal operation mode to the energy saving mode according to at least one of an instruction for entering into the energy saving mode and satisfaction of a condition that the plurality of load units are inactivated.

16. The method of claim 15, wherein the changing includes at least one of the following:
substantially shutting down the first power except for the second power to be used by a control mechanism of the host apparatus according to the energy saving signal during the energy saving mode;
connecting the specific load component to the second power source according to the energy saving signal; and
stopping charging the second power source.

17. The method of claim 15, further comprising:
monitoring an output voltage of the second power source; and
switching off a power supply line from the second power source to the specific load component when the monitoring step detects that the output voltage of the second power source is smaller than a reference value.

18. The method of claim 15, further comprising:
connecting the specific load unit to the second power source according to the energy saving signal during the energy saving mode;
monitoring an output voltage of the second power source; and
disconnecting the specific load unit from the second power source when the monitoring step detects that the output voltage of the second power source is smaller than the reference value.

19. The method of claim 15, further comprising:
connecting the specific load unit to the second power source according to the energy saving signal during the energy saving mode;
monitoring an output voltage of the second power source; and
disconnecting the specific load unit from the second power source when the second power source reduces an output voltage below the reference value.

20. The method of claim 15, further comprising:
connecting the specific load unit to the second power source according to the energy saving signal during the energy saving mode;
monitoring an output voltage of the second power source; and
determining that an output voltage of the second power source is below a reference value based upon the energy saving signal and the step of monitoring;
disconnecting the specific load unit from the second power source when the output of the second power source is determined to be below the reference value.
